(19) United States
(12) Patent Application Publication
(10) Pub. No.: US 2003/0023408 A1
(43) Pub. Date: Jan. 30, 2003

(54) System for collecting and storing information

(76) Inventors: Robin Wight, Birmingham (GB); Mark Sutcliffe, Birmingham (GB)

Correspondence Address: Michael D. Kaminski, FOLEY & LARDNER, Washington Harbour, 3000 K Street, N.W., Suite 500, Washington, DC, 20007-5109, US

(21) Appl. No.: 09/799,093

(22) Filed: Mar. 6, 2001

(51) Int. Cl. G06F 15/00; G06F 17/40

(52) U.S. Cl. 702/187

(57) ABSTRACT

The invention is an improvement to previous data acquisition systems in which log sheets are used to record events such as faults with machinery. The invention provides a system which allows a potential future occurrence to be defined rapidly and very easily. The system thereafter allows the actual occurrence of such events to be recorded as they happen. The event definition can be constantly updated so that more information on the nature of the event can be obtained as time progresses. The system therefore allows the impact of potential problems to be assessed quickly and at low cost. The system can also be used to diagnose problems and provide real time feedback about the occurrence of events. A preferable embodiment of the system comprises an input means attached to a controller, the controller comprising an event definer connected to an input means configurer. The controller is further connected to a database for storing data about the occurrence of events.

### FIELD OF THE INVENTION

The present invention relates to a system which can be used whenever it is desired to collect and collate information. The information can in general be of any nature but the present invention is especially applicable to information relating to processes, such as industrial processes.

### BACKGROUND ART

There is a desire within industry to seek the continual improvement of industrial processes such that they may be carried out less expensively, more productively, or more reliably for example. However, before processes can be improved, it is necessary to collect, collate and analyse information relating to the existing process. This means that it is necessary to have systems in place which allow relevant information to be obtained. Conventionally, such systems have taken one of two forms.

The first type of information collection system is illustrated schematically in FIG. 1 of the accompanying drawings. FIG. 1 is a flowchart showing the processes which need to be carried out by personnel responsible for a piece of machinery carrying out part of an industrial process, in order to collect and record relevant information regarding that machinery and the process it carries out.

Typically, a log sheet is designed which is used to record any faults or irregularity relating to the machinery in question. Such a log sheet would typically be tabular and would have spaces for writing in the date, time, nature of the fault, amount of time the machinery was offline for etc. Thus, step M1 of FIG. 1 shows the initial preparatory step of creating the log sheet. This log sheet is then placed in a location near to the machinery in step M2.

It is determined in step M3 whether or not a fault or irregularity has occurred. For example, the machinery might break down due to overheating or a component might fracture. Similarly, a component might become loose resulting in unreliable or intimitant operation. Once it is determined that a fault or irregularity has occurred, the machinery is inspected in step M4 to determine the nature of the fault/irregularity.

At this stage, a decision is made in step M5 as to whether the fault/irregularity can be remedied easily. For example, if the fault/irregularity has been determined in step M4 to be due to a loose screw, it would be determined in step M5 that this fault can be fixed easily by tightening the screw. The screw would then be tightened in step M6 and the process would be restarted. Typically for such minor incidents, M3, M4, M5 and M6 might be carried out in quick succession, for example in less than 30 seconds in total. This is especially the case when the machinery is known by the machine operator to have a particular peculiarity. In such cases, the experience of the machine operator means that the problem can be resolved very quickly and the machine can be brought back into an operating condition very quickly. Such minor faults and irregularities might be expected to occur regularly throughout a working day and the machine operator or maintenance technician, if nearby, might be justified in assuming that a single such minor fault did not seriously impact the productivity of the machine.

If in step M5 it is determined that the machine cannot be fixed easily and quickly, a different procedure is followed. Firstly, the nature of the fault is recorded on the log sheet in step M7, then (step M8) a decision is taken to call a mechanic or other qualified person to attend to the machine. The machine is then fixed (step M9) and the log sheet may be updated with further information such as which components were replaced (if any) and how long the machine was broken down for.

Later on, perhaps at the end of the day, or the end of the week, the log sheets for each piece of machinery can in theory be reviewed and an analysis can be made of the productivity, reliability or efficiency of each machine. This analysis may then yield ideas for improving the machinery such that the possibility for future occurrences of the fault is reduced (step M12). However, this rarely happens in practice due to the fact that the review takes time which is often thought to be better spent in other ways.

Thus, traditionally, any machinery improvements which have been developed have been based (to some extent unconsciously) on seeking solutions to the larger faults which put the machine out of action for a significant amount of time, this being inevitable because the system does not make it worthwhile to fill in a log sheet recording the minor faults. For the many minor and small irregularities, it is nearly always quicker for the machine operator to fix the machine themselves than to take the trouble of filling out a log sheet. Thus, the attitude prevails in industry that it is more productive to get the machine up and running as quickly as possible rather than to spend extra time filling in a log sheet while the machine is off-line. To do such a thing would be counter-intuitive and would involve resisting a basic human nature.

The second type of conventional information collection system has been used in connection with machinery controlled automatically under the known SCADA (System Control And Data Acquisition) system. Such systems are generally able to recognize when a piece of machinery stops and they are able electronically to record logs of exactly when the machine was on-line and off-line. Referring to FIG. 2 of the accompanying drawings, it can be seen that when a fault occurs with a piece of machinery at step N1, the SCADA system writes an entry to an electronic log that the machine has stopped. Then, in steps N3 and N4 (analogous to steps M4 and M5 in FIG. 1), the machinery is inspected and it is determined whether the fault can be dealt with easily. If so, the machinery is fixed in step N5 and the procedure advances to step N7 in which the SCADA system electronically logs the fact that the machine is back on-line. If in step M4 it is determined that the machinery cannot be fixed easily, a mechanic is called in step N6 to fix the machine. Again, the procedure flows to step N7 wherein the SCADA system electronically logs the fact that the machine is now back on-line.

At the end of each day, week or month etc., the SCADA records are analysed and it is apparent from these when the machine was running and when it was stopped. Such records are commonly used as a measure of plant productivity which might be defined as (running time)/(stopped time+running time) for example. However, the SCADA records often provide no information as to what the cause of the various stoppages were. It is therefore necessary in step N9 to ask the personnel involved (e.g. the machine operator or supervisor) what their recollection is. The particular context of any given situation may have a substantial impact on the cause. There is an inherent disadvantage in this in that those involved may not be able to recall precisely or correctly what happened to the machine. Also, there is a delay between the event occurring and obtaining correct data. It is to be noted that the SCADA information on its own is of absolutely no use in identifying faults and thus potential improvements. It is often only once the human context has been added to the factual information recorded by the SCADA system that potential improvements can be identified.

Both of the above conventional systems have the key disadvantage that the small faults and irregularities which are easily fixable by the machine operator or maintenance technician are never recorded. In the first system, only those larger faults which necessitate the calling out of a mechanic are recorded. These larger faults are often the most serious taken in isolation, but the small faults and irregularities can be much more frequent, meaning that they can have a large cumulative effect over the day without the machine operator necessarily being aware of this. With the second described system, the problem exists that the reason for the breakdown is nowhere recorded. When people are asked what happened at a later time, they invariably are only able to recall the big problems and the small, but frequent problems often go unmentioned.

A further problem with both of the above-mentioned systems lies in the fact that it is impossible to determine how costly individual problems are to the overall process. The managers of the process are therefore not in a position to determine whether it is cost-effective to make efforts to irradicate the problem.

An additional problem exists with both systems in that the determination of the problem with the machinery which takes place when the machinery is inspected (eg step M4 or N3) may initially be wrong. Thus, there is often some trial and error involved when fixing the machinery and it can sometimes be difficult to diagnose the problem exactly.

There further exists a problem that in both of the above systems the log sheets or SCADA records are analysed at most on a batch basis (for example at the end of the week or month) and so there is an inherent time lag between the problem occurring and any one knowing it has occurred.

### SUMMARY OF THE INVENTION

It would therefore be desirable if there were some system which allowed information to be collected in relation to any problem occurring with the machinery, such collection having a minimal risk of increasing the time it takes to fix the machinery.

Also, it is desirable that information can be collected with a minimal amount of configuration beforehand. It would be advantageous if such configuration was implemented in parallel with information collection, in real time so that the data already collected can have a bearing on how future data is collected.

Further, it is desirable to provide a system which allows human context to be easily assigned to abstract data with a minimum of delay.

Accordingly, the present invention provides in a first aspect a method comprising:

providing a user with an alterable selection of conditions;

feeding back the user's assessment of the existence of one of these conditions; and

logging this assessment in a database.

Preferably, each of the conditions comprises a potential future occurrence and/or the selection of the conditions is alterable in that the conditions may be defined or removed.

The present invention provides in a second aspect a system for collecting and storing information about a process comprising:

a system controller comprising event defining means which allow an event to be defined by a user, said event being a potential future occurrence in said process;

input means connected or connectable to said system controller, said input means being operable to accept inputs relating to the occurrence of said pre-defined event;

said system controller further comprising means responsive to said event defining means for configuring said input means such that inputs to said input means cause the recording of the occurrence of said pre-defined event; and

a database stored in a memory for storing data relating to the fact that said pre-defined event occurred.

The system controller is preferably a programmable computer loaded with appropriate software. In a preferred embodiment this software allows a plurality of events to be defined such that the occurrence of one of these events may be input using the input means.

The system controller might typically be in the form of a PC located in a site office and the input means might typically be operable remotely from the system controller (for example in the vicinity of the machinery carrying out the process).

The system is able to support a plurality of input means, each one being used independently to register the occurrence of events. Each or some of these input means may be provided with a display connected to the controller and the display may be used to display questions answerable using the corresponding input means.

In one embodiment, the input means comprises a numeric keypad and the occurrence of an event is input by typing a number associated with the event. Alternatively, the input means may comprise a number of distinguishable buttons (for example of different colours) and the occurrence of an event is input by simply pressing a button. In this case, the display means may be used to indicate which button corresponds to which predefined event. The input means is advantageously a handset in which all (eg 16) the buttons can be assigned to receive an input relating to a specific event. The handset is preferably small and compact.

The system preferably contains some means for analysing the database such that reports on the data may be created. These reports are preferably created in real time and the software can be such as to allow the user to predefine the type of report they want to create.

To ensure that users comply with the requirement to register the occurrence of an event, the system may be operationally linked to apparatus involved in the process. Thus, the system may be arranged to prevent the process from restarting once stopped and only allow the process to restart once the occurrence of a predefined event has been recorded.

In a third aspect the present invention comprises a method of collecting information, said method comprising:

using a programmed computer system to define an event, said event being a potential future occurrence in a process;

providing a monitor of the process with means to input the occurrence of said event;

using said input means to indicate to said programmed computer system that said event has occurred; and

storing the fact that said event has occurred in a database by storing data identifying said event.

Preferably the controller or input means is also used to measure automatically when the occurrence of the event is inputted so as to obtain a time which the occurrence of the event is recorded. This time may then be stored in the database.

The step of defining the event preferably comprises inputting to the programmable computer system a description of the potential future occurrence. At this point in time, a unique identifier may be associated with the event by the programmable computer system. This unique identifier may be a number in which case the input means can comprise a numerical keypad and using the input means can comprise inputting this number.

Typically, the database will be analysed in real time and such an analysis may comprise calculating the number of times that an event has been stored within a selected time period. The data stored in the database may have calculations performed upon it such that values useful in making a business decision are obtained. For example, the cost to the business due to the occurrence of a particular event may be calculated. This is particularly useful when the event relates to a perceived fault in the process since it allows a business decision to be made as to whether to continue monitoring said fault. For instance, if a perceived fault is monitored and it is determined that it represents negligible cost to the business, a business decision may be made to discontinue monitoring this fault using the system of the present invention.

The event may be defined not only by a description of the potential future occurrence but also by a potential reason for the future occurrence. This allows useful context to be added to abstract data and increases the chances of a subsequent analysis resulting in the identification of an improvement to the process in question.

Typically, a plurality of events will be defined. When a degree of automatic control is used in the process in question (eg SCADA control), it may be possible for the system to recognize that some unknown event has occurred without it knowing exactly what has occurred or what the reasons are for the occurrence. It will then be necessary for the monitor to specify which of the plurality of possible events has occurred using the input means. If desired, the system can be arranged such that once some event is known to have occurred, the process will not be restarted until the monitor uses the input means to indicate the occurrence of one of the plurality of events. This ensures that all events are recorded and that the process cannot stop and restart without an event being recorded.

The potential future occurrence may be the need to submit an idea or suggestion. In this case the event can be called “idea” and when an operator wants to submit an idea, they record the occurrence of the “idea” event and type in, when prompted, their idea/suggestion.

If desired, it is possible to configure the system such that the input means is operated in two separate steps; the first step merely indicating that some event has occurred and the second step indicating which event has occurred. In such a case, and equally in the case when the system itself is capable of acknowledging the occurrence of an unknown event, the use of the input means in the second step may comprise answering questions displayed on a display corresponding to the input means. The questions are in this case defined to identify which of the plurality of events has occurred.

The present invention allows results to be displayed in real time throughout the working day. This significantly reduces the time lag between obtaining the information and acting upon it.

The present invention provides in a fourth aspect a computer program which, when loaded on an appropriate programmable computer, carries out the following method:

allowing in an event defining step, a user to enter details of a potential future occurrence in a process;

receiving a signal from an input means provided to a monitor of said process;

analysing said signal from said input means and determining if said signal corresponds to said defined event; and

if said signal corresponds to said defined event, storing in a database the fact that said defined event has occurred by storing data identifying said event.

The program will ideally allow a plurality of different events to be defined and will associate a unique identifier with each event at the time that they are defined.

The program is preferably operable to interface with software controlling the process such that an input from the process can be used to trigger the occurrence of an event and outputs can be made from the system of the present invention to trigger the start/stop of the process. For example, the software may be arranged to wait for an input from the input means after it has received a signal from the software controlling the process indicating that an irregularity has occurred in the process. Similarly, the program may be arranged to provide a signal which stops the process once it has received the signal indicating an irregularity in the process. The program may then be arranged to output a restart signal to the software controlling the process only once it has received a signal from the input means recording the occurrence of a defined event.

The program can be operable to analyse the database and calculate the number of times that an event occurrence was stored in a selected time period. Other calculations may be made on the data in the database and these calculations may be user-definable.

To aid in diagnosing a fault or other irregularity in the process, the program may be operable to pose questions the monitor which aid in diagnosing the irregularity. The questions can be designed such that their answers identify which of the plurality of events has occurred.

The program is preferably operable to review the database regularly such that information derived from the database is displayable on a real-time or near real-time display.

### BRIEF DESCRIPTION OF THE DRAWINGS

Embodiments of the invention will now be further described, by way of example only, with reference to the accompanying schematic drawings, in which:

FIG. 1 is a flow chart describing a prior art procedure for collecting information using manual log sheets FIG. 2 is a flow chart describing a prior art procedure for collecting information using SCADA equipment;

FIG. 3 shows one configuration of the system of the present invention in which a controller is connected to a database and an input means;

FIGS. 4A and 4B show procedures for defining an event and recording the occurrence of an event respectively;

FIGS. 5A and 5B show alternative procedures for defining an event and recording the occurrence of an event respectively;

FIG. 6 is a flow chart showing how a potential problem is tracked using the event engine of the present invention;

FIG. 7 shows the configuration of a system in which the controller of the present invention interfaces with a SCADA controller so as to provide enhanced performance;

FIG. 8 shows a flow chart describing the procedure for forcing compliance with the requirement to input an event after the machine has stopped;

FIG. 9 is a graph showing when a machine is running and not running over a certain period of time;

FIG. 10 is a flow chart showing how the recording of an event in the database is suppressed if that event occurrence is triggered within a certain time period of the last time that occurrence was triggered;

FIG. 11 is a graph describing how the event suppression procedure operates;

FIG. 12 is a diagram showing a possible architecture for implementing the present invention;

FIG. 13 is a diagram giving an overview of the structure of the system according to the present invention;

FIG. 14 is a typical screen display used for defining an action;

FIG. 15 is a typical screen display used for defining how an action is triggered in response to an event;

FIG. 16 is a typical screen display showing the parameters which are passed to an external system when an action is triggered;

FIG. 17 is a diagram describing how the various entities of the present invention interrelate;

FIG. 18 is a flow chart showing a procedure for processing an action entity;

FIG. 19 shows a process for making metal bars and shows how the stoppage of one piece of machinery can affect different parts of the process; and

FIG. 20 illustrates a card having bar codes for use in triggering event occurrences according to the present invention.

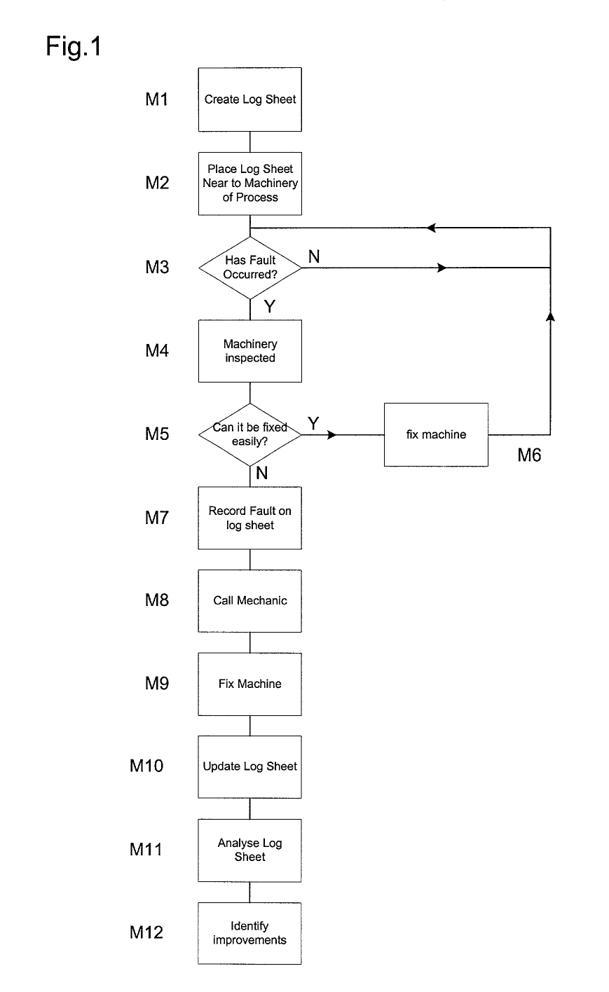

### DETAILED DESCRIPTION OF THE EMBODIMENTS

The present invention addresses the problems inherent in the prior art by providing a system which allows for faults/irregularities in a process, such as an industrial process, to be recorded in real time with negligible effort by the person monitoring the process. This is achieved by providing the person monitoring the process with suitable means for registering that an event has occurred. Further, the system is configurable such that potential events are pre-defined so that it is not necessary to write a complete description of, for example, a fault or irregularity each time one occurs.

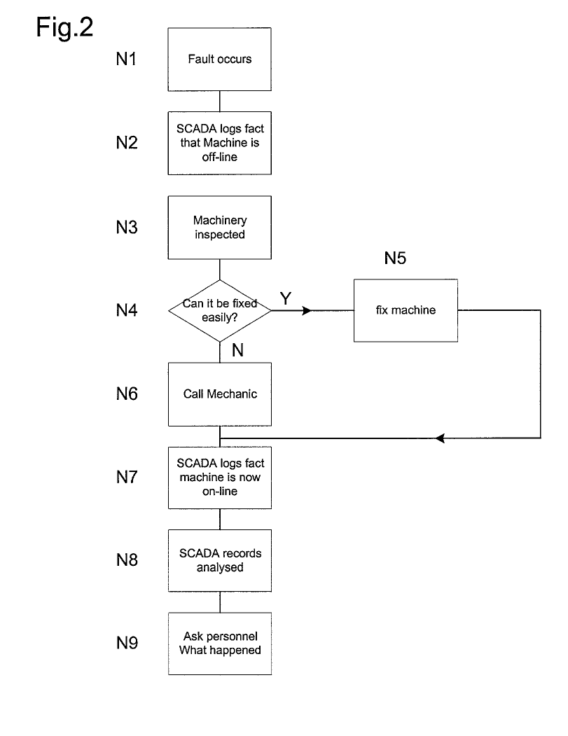

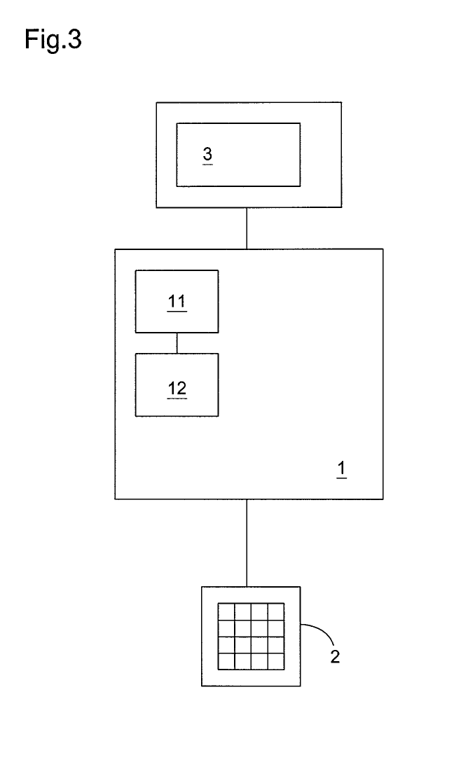

A schematic representation of the apparatus involved in the present invention is shown in FIG. 3. A controller 1 is connected to an input means 2 and a database 3. The controller 1 is operable to write data to the databases and to receive inputs through the input means 2. The input means 2 is preferably a touch screen but may be any type of input device such as a keypad, keyboard, WAP phone, mobile phone with SMS messaging, PDA, internet connection etc. The invention can support such a wide range of inputs because it preferably uses the JAVA language which is compatible with such devices. Further, the input means 2 need not be permanently connected to the controller 1. For example, a PDA can store the triggering of event occurrences locally as an XML file and synchronise later by uploading the XML files.

A further advantageous input means uses bar codes. A handheld RF bar code scanner can be used to read a bar code printed on a “menu”. Each bar code has printed next to it the description of the relevant event and an event occurrence can be registered by scanning the appropriate bar code with the handheld scanner.

In a similar vein a credit card sized card can be constructed having a different bar code along each of the four sides, on the front and back (giving eight bar codes in all). Next to each code is printed a description of the event to which the code relates. Then, when it is necessary to trigger the occurrence of an event, the user simply swipes the card through a bar code scanner in the appropriate orientation so that the appropriate event is triggered. Such a swipe card is shown in FIG. 20. As can be seen, the swipe card 21 has a bar code 22 along each of its edges and an event description 23 adjacent to the bar code. The event described in a description 23 can then be triggered by passing the corresponding bar code 22 through a tabletop bar code scanner or the like.

Event Definition

The controller 1 further comprises an event definer 11 connected to an input means configurer 12. The event definition represents the minimum up-front configuration needed to implement the present invention. It is not necessary to analyse a problem first and identify every possible outcome. Rather, guesses of only one outcome can be made and this outcome is monitored.

The event definer 11 is operable to allow an “event” to be defined by the user. This is typically done by a user inputting, using appropriate input means, a description of a potential future occurrence in process. These input means may be the input means 2 or they may be other input means such as a keyboard (not shown in FIG. 3) separately attached to the controller. The potential future occurrence in the process comprises anything which can be imagined as happening. The user is free to input a description of any occurrences however remote it may be. Typically, the occurrences relate to faults or breakdowns in the process since these are the events which the user can benefit most from monitoring. The event definer 11 thus allows one or a plurality of such “events” to be defined. Typically, each event will be related to a specific type of asset, for example the event “motor overheated” is related to the asset “motor”. Thus, to define an event, a user typically clicks firstly on an asset in a list of assets and defines an event only for that asset. The input means configurer 12 is responsive to the event definer 11 and serves to configure the input means 2 such that inputs to the input means cause the recording of the occurrence of one of the events defined using the event definer 11. The input means configurer 12 may be automatic or user controllable. In an automatic mode, the input means configurer may assign newly defined events to the next available button on the input means 2. Thus, the first defined event would be assigned the button numbered “1”, the second defined event would be assigned the button numbered “2” and so on. In the user controllable mode, the input means configurer 12 may be set by the user such that specific defined events can be configured to specific buttons of the input means 2. In this way, the user can choose which button, or combination of buttons, is used to signal the occurrence of each event. Further, the input means configurer 12 may allow the user to set up hierarchies of questions which the monitor of the process is asked, the answers to which signal the occurrence of an event (or not).

Event Occurrence Recording

Once one or more events have been defined, the system can be immediately used to record the occurrence of the events.

The process to which the system is applied is usually monitored by a particular person (the “Monitor”) who has responsibility for recording any fault or irregularity. When a fault or irregularity occurs all that person has to do is press the appropriate button on the input means which corresponds to the already predefined event relating to the fault or irregularity that occurred. Pressing the button takes a matter of seconds and there is no need for the monitor to have to fill in a logsheet manually or remember the cause of the stoppage. If there is no predefined event corresponding to the fault or irregularity, then the button corresponding to a standard event defined as “no relevant event defined” is pressed. This can optionally be used to trigger the system into requesting that a new event is defined immediately. The monitor can define the event and this will be correlated with a button on the input means 2 so that future occurrences of this event can be recorded. The system can therefore be adjusted very quickly with immediate effect. When an event occurrence is triggered, various data are stored. Such data typically includes an event identifier, a time stamp, data identifying the user who was logged in when the event occurrence was triggered and which asset the event relates to.

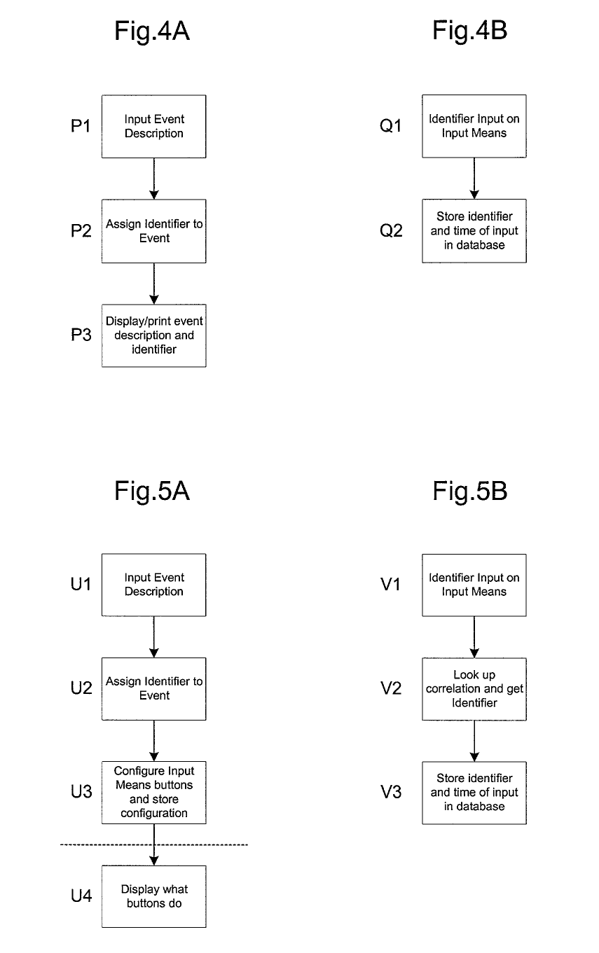

FIGS. 4 and 5 show two alternative pairs of procedures which are used to set up, and record the occurrence of, events.

FIG. 4A shows the procedure for defining an event in the case when the input means 2 is numerical keypad.

Firstly, in step P1, a description of a potential future occurrence is input using the event definer 11. Next, in step P2, a numerical identifier is assigned to the event that has just been input by the controller 1. This identifier may be the same as, or in addition to, the unique identifier which is used internally in the controller 1 to identify the event and which is stored in the database 3. The identifier assigned in step P2 is made known to the user in step P3, either by displaying it or printing it. This step P3 may take place after a plurality of event descriptions have been input and each event has been assigned a unique identifier. Thus, a procedure in which events are entered, identifiers are assigned and then in which a summary of all the event descriptions and their unique identifiers are fed back is provided. This printout may then be placed near the input means 2 so that the monitor of the process in question is readily able to determine what number to type in when each event occurs.

FIG. 4B shows the procedure applied by the monitor of the process when it becomes necessary to record the occurrence of an event. When something of note occurs in the process which has been predicted in the sense that an event has been defined covering this occurrence, the user simply types in the identifier corresponding to that defined event. The input means transmits this identifier to the controller (either immediately or in a batch process, e.g. at the end of the day) and the controller causes an entry to be made in the database 3 that the event occurred at a particular time. If the input means is operable to transmit the fact that an event occurs only using a batch process, then it is necessary for the input means also to transmit the time at which the event occurred. If the input means is connected to the controller on a real-time basis, the controller can determine the time that the event occurred by simply referring to its own internal clock whenever it receives a signal from the input means indicating that an event has occurred.

Thus, the system as a whole is operable to record the fact that a particular predefined event occurred at a particular time.

A slightly different procedure is shown in FIG. 5. Steps U1 and U2 in FIG. 5A are substantially the same as steps P1 and P2 in FIG. 4A. In these steps, the description of a potential future occurrence is entered and an event is defined. However, in this procedure, step U3 ensures that the input means is properly configured by storing a correlation between particular events and particular buttons of the input means 2. The process may be automatic in that the input means configurer 12 simply allocates the next available button on the input means 2 to each newly defined event. Alternatively, the user can specify which buttons correspond to which events.

In an optional step U4, the system can display what the buttons do by displaying the description of the event adjacent to some identifier of the buttons. For example, a screen could be provided near the input means 2 showing a graphic depiction of a group of coloured buttons, each button corresponding to a button existing on the input means 2. Next to the graphic depiction of the buttons on the screen could be displayed a description (or a brief description entered by the user if necessary) of the event which corresponds to that button. In this way, the monitor of the process is left in no doubt as to which button corresponds to which event.

In FIG. 5B, it can be seen that the monitor of the process only has to press a single button (step V1) in order to register the occurrence of a particular event. When a button is pressed, the controller 1 only has to refer to the correlation set up in step U3 to identify which event has taken place. Then, (in step V3) the fact that the event took place can be stored in the database 3.

The input means 2 can preferably take the form of a touch screen having user definable buttons of selectable size. This allows the user to select an appropriate size and arrangement of buttons, for example, regularly triggered events can be correlated with larger buttons.

From the above description it is clear that before information concerning the occurrence of an event can be collected, it is necessary to define an event corresponding to this occurrence. Thus, a certain amount of foresight is required for the system to operate. One advantage of the system is that an event can be defined very quickly (within a few minutes) and the input means can be configured very quickly such that an immediate result as to the occurrence (or not) of the defined event is available. The impact of any suspected occurrence can therefore be evaluated very quickly such that an appropriate business decision can be made. For example, if a Manager suspects that a wobbly component is causing a loss in productivity, they can quickly define an event described as “component X wobbled causing machine stoppage, it was tightened by screwdriver”. Once defined, the occurrence of this event could be registered by a monitor using the keypad located near to the machinery having component X. Then, each time component X wobbled and needed to be tightened, the monitor of the process would simply press the button on the keypad to indicate that the defined event occurred. This would carry on throughout the day and at the end of the day the Manager would have stored information relating to every time the defined event occurred. The machinery monitor would not be unduly hindered by the fact that a button needed to be pressed since this procedure only takes a second or two. The business manager can analyse the data at the end of the day, perhaps in conjunction with data obtained from SCADA records and would be able to quickly quantify the cost attributable to the fact that component X wobbled. For example, it would be possible to identify from the SCADA records how much time the machine was off-line due to the fact that component X needed tightening 20 times in the day. The manager is then able to decide very quickly whether the problem is worth addressing or whether it is actually having a negligible effect on the business. If the problem is worth addressing, the manager can direct resources to redesigning or adapting the machinery to prevent the problem occurring in the future. Alternatively, the event can be re-defined in real time and another problem can be tracked.

The system is also appropriate to a team culture. Machinery users and managers who have regular team meetings can use the meetings to identify possible problems with the machinery and a designated member of the team can then define events relating to these problems so that they may be tracked. The results can then be discussed at the next meeting, where the events can be modified, if necessary.

The system therefore allows a potential problem to be tracked once it has been identified. If the information collected about the problem then shows that it is potentially important, further definition can be added to the event to perhaps identify possible causes of the problem. For example, it might be suspected that wobbly component X is due to the fact that another component is vibrating excessively. If the manager suspects this, he can define another event which states that component X was wobbling and that component Y was vibrating excessively. The monitor would then be able to choose between triggering this event, or the one where component Y does not vibrate excessively, depending on the facts. The results would then tell the manager whether there was any correlation between component Y vibrating and component X becoming wobbly. Alternatively, farther definition can be added to the event such that the operator is asked if component X was wobbling when the event occurrence is triggered.

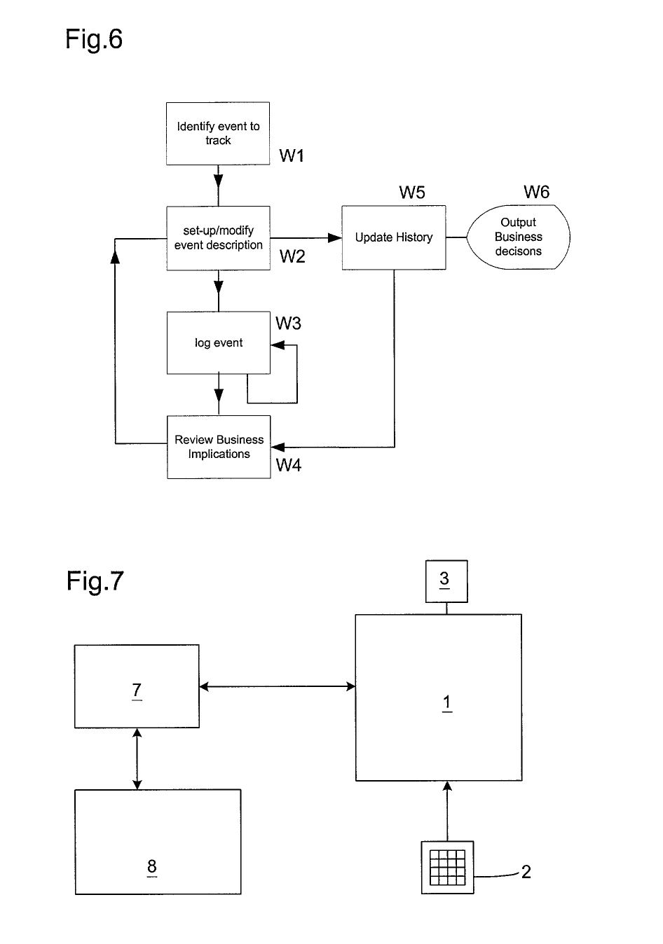

This procedure is summarised in FIG. 6.

Firstly, in step W1, there is identified an event to track. This event is a problem which is suspected to be causing a loss of business. Alternatively, it may just be some aspect of the process on which more information is required. In step W2, an appropriate event definition is input so that the identified event may be tracked. As the process is carried out, the occurrences of the defined event are logged by the process monitor in step W3. After a certain amount of time, the database can be reviewed and it can be ascertained how many times the event occurred and typically what the cost associated with the event is. The business implications of this can then be analysed and from this the nature of the event that needs tracking may be altered. Thus, after step W4, the procedure returns to step W1 and the event definition is modified. The system therefore provides an intuitive; speedy and immediate way of monitoring or diagnosing the problem. If the user wants to investigate the effect of using different parameters, such as the cost per hour associated with a machine stoppage, this is possible due to step W5. For example, the user may decide a machine stoppage costs twice as much as previously thought. In this case, the event log (history) is updated with the new cost figures so that results stretching back in history are updated and the correct cost is attributed to every stoppage that occurred in the past.

Problem and Solution Events

Two types of events can be identified. A “problem event” is an event relating to a potential future occurrence that it is in someway problematic. For example, “reactor overheating” or “pump broken” are examples of problem event. A “solution event” is an idea or suggestion of an employee for how a problem can be solved. Solution events can be linked to problem events so that it can be seen whether an idea in the form of a solution event has had an impact on a problem in the form of a problem event. For example, a sheared pin can be reported as a problem event and can be tracked for several weeks showing a significant cost in lost business. Someone can submit an idea (as a solution event) to replace the pin with a different material. A relationship is then made between the solution event (replacing the pin) and the problem event (the pin shearing). By comparing how many times the problem event occurs in time periods before and after the solution event, it can be determined whether the idea has reduced the lost business or not.

Parameters

Certain “parameters” can be defined which affect the form of the data that is presented to the user. One such parameter might be “cost” which is the measure of how much a machine costs the factory if it is off line for one hour, say. When the user is presented with the results, the event log (ie the database which stores data relating to which event occurred when) is combined with parameter data to provide meaningful results. For example, the event log can be used to determine for precisely how much time a machine was off-line over the last day, week, month etc. This time can be multiplied by the “cost” parameter to determine how much money the business has lost due to the stoppage of this machine over that time period.

The use of such parameter allows the user to experiment with the effect of attributing different costs to the machine stoppage. When a parameter is changed, all the results for all time are affected and the result history is updated retrospectively. However, the actual event log is not changed since this is the primary source of data. It is only the results presented to the user that change when a parameter is changed. This feature has the important advantage that results can be reconstructed from logged data and that the parameters used in calculating the results can be easily and quickly changed and can have the immediate effect on all of the results.

Thus, the present invention can reconstruct an historical trail from a minimum of key data, ie. From an audit log containing only the event ID and a timestamp. The system can redefine the profile of an event and reconstruct a filly populated history table of costs and durations between events.

Another advantage of the present invention is that the parameters do not need to be set up before an event is defined. The parameters can actually be set up well after an event has been defined and well after a monitor has started to regularly trigger the occurrence of the event. The raw data is continuously logged and results are available in the form of such raw data. If more meaningful results are required, parameters can then later be set up and these parameters are then used with all of the logged data. This allows events to be quickly defined and also allows them to be recorded almost immediately. There is no need to dictate up-front how the data will be presented or what factors are important in calculating meaningful results.

Integration with SCADA System

The present invention can be seamlessly integrated with existing SCADA (System Control and Data Acquisition) systems already used to control machinery forming part of a process. In particular, the controller 1 (see FIG. 3) can be put in two-way communication with the SCADA controller 7, which itself is controlling a piece of machinery 8. This is shown in FIG. 7. This arrangement allows communication between the controller 1 and the SCADA controller 7 to provide further benefits. Firstly, SCADA data (such as the periods of time for which the machinery was running or not) can be stored in the database 3 along with the data relating to the occurrence of defined events. Therefore, an event whose occurrence is registered using the input means 2 during a period when the SCADA data indicates that the machine is off-line might be associated with the fact that the machine is off-line. In other words, if the user registers that a particular problem occurred at a time when the machine is off-line, it can be inferred from this that the machine being off-line is due to that problem. The length of time for which the machine is off-line would be available from the SCADA data and so the impact of the problem can be quantified.

A further benefit is that the controller 1 can interface with the SCADA controller 7 in such a way as to prevent non-compliance with the system.

An unmotivated or overworked machinery monitor may be tempted to fix the machinery without registering the occurrence of an event. To prevent this, the controller can monitor when the SCADA system indicates that the machine has gone off-line. The controller 1 can then send a signal to the SCADA controller 7 which prevents the machine being restarted until some input has been registered on the input means 2. This forces adherence to the data capture procedure.

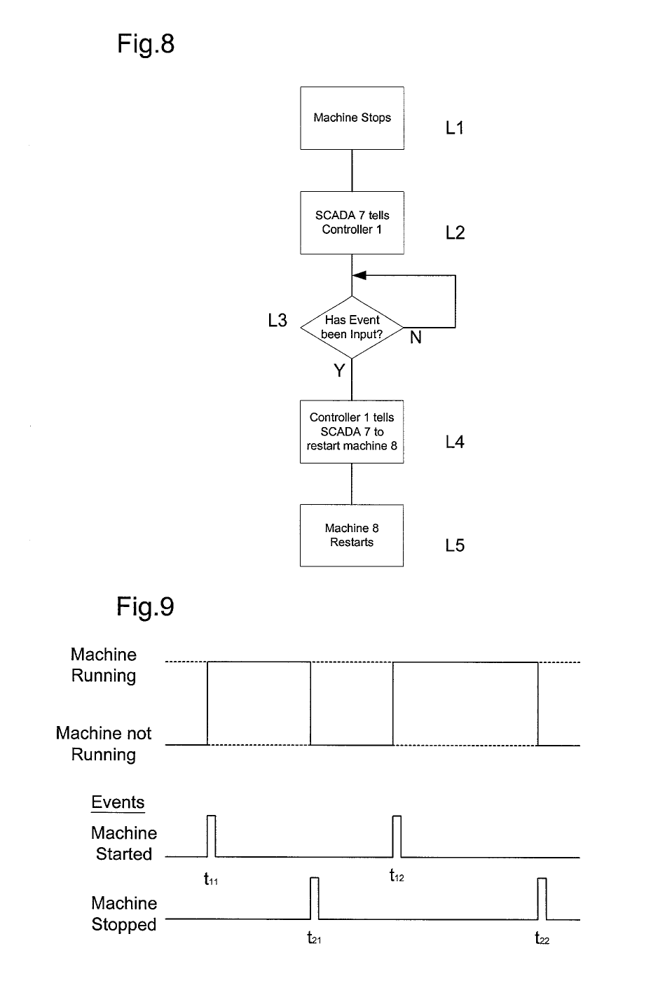

This procedure is shown schematically in FIG. 8.

When the machine stops (step L1), the SCADA controller 7 sends a signal to the system controller 1 indicating that the machine has stopped. The system controller 1 then waits until an event occurrence is input using the input means 2 (step L3) before sending a signal to the SCADA controller 7 that the machine can be restarted (step L4). Then, in step L5 the machine restarts once the problem has been fixed.

The system of the present invention can also be combined with a pre-existing SCADA system in a configuration in which the occurrence of the defined events are triggered manually by machine operators. In such cases, data obtained by the SCADA system is recorded at the time that an event occurrence is manually triggered. Which data is recorded is determined by how the event is set up. For example, an event could be defined as “too much steam coming from boiler”. If there is no steam sensor, then the SCADA controller will not be able to trigger the occurrence of this event itself. Thus, the machine operator uses the input means 2 to trigger the occurrence of the defined event when it is assessed that there is too much steam. At the moment that the occurrence of the event is triggered on the input means 2, the system of the present invention polls the SCADA system and obtains current values for process parameters such as temperature etc. Thus, even more useful context is added to the data leading to a higher probability that the reasons for the problem can be later identified.

In this document, it is to be understood that references to “SCADA” systems include any systems under some degree of automatic control, such as those systems which use a programmable logic control (PLC). When a PLC is used to control a process, the system of the present invention can interface directly with the PLC so that appropriate process conditions can be recorded by the system of the present invention and so that the present invention can send signals to the PLC to stop or start the process for example.

In the case when the SCADA system is operable to cause the triggering of event occurrences in the present invention, such occurrences can initially be logged and later displayed. An operator can then add comments and context to the automatically triggered event occurrences at the end of the day or hour for example. In fact, human context can be added to the event log at any time in a preferred implementation of the invention.

Diagnostic Assistance

A display apparatus may optionally be provided adjacent to each input means to assist the process monitor in diagnosing the problem they are logging. The display means (which may be the same display means that are used to indicate the correlation between the buttons on the input means and the predefined events) can be used to display a series of questions to the process monitor. The input means may have YES/NO buttons for example and the answer to each question can prompt the asking of the next question so that a hierarchical question structure is provided. In this way, the system dynamics provide a structured series of questions to the user such that the appropriate event occurrence for logging can be established. Furthermore, the questions can be used to make suggestions to the process monitor as to how to solve the problem. Thus, the questions can serve a dual purpose in that they help the machine to be fixed quickly and that they facilitate the logging of an accurate cause.

As will be described later, it is possible to define “actions” which are carried out automatically when certain events are triggered. For example, a work order can be raised automatically when an event is triggered and this work order can include data corresponding to the answers to the questions that were posed when the event occurrence was initially triggered. This brings about an advantage in that the technician responding to the work order already knows about the problem and is automatically summoned to fix it. Because they have data relating to the problem, there are able to arrive on the scene properly prepared.

Summarised Data

The above description describes how the data can be captured and stored. However, the volumes of data can make its analysis prohibitive, i.e. if the system has collected ten years of a machine stopping and starting two hundred times a day, asking a report generator to immediately answer a sum total of the business lost would tax the best of computer processors. The system may therefore comprise a pragmatic data summary table storage, which dynamically works out what summarised data will be required. These summary tables are then maintained in real time as data is collected. E.g. if the end user asks for how much did the problem cost the business in 2001, the single figure answer is stored waiting to be asked, providing a real-time response to the question. It is, of course, unrealistic to store every combination of every question that could possibly be asked, as the total data volume would exponentionally grow with every new piece of information entered into the system, but the system can store sensible roll-up points that can reduce complex analysis to a fraction of the processing power required to answer the question from raw logged data. How the roll-up points are determined is shaped by the industry in which the invention is applied. The type of data required will therefore vary among possible applications.

The data is thus stored and maintained in a summarised form and in this form it can be embedded into portal and dashboard reporting leading to advantageous reporting performance.

The data can be fed back in real time to those registering the occurrence of events by displaying graphs and tables on a display screen. Similarly, results can be fed back using an electronic tickertape display.

Properties

A “property” is a variable relating to some property of the asset (piece of machinery) or process. For example, in a pressing machine, either gold bars or lead bars can be made. A property can be defined as “current product” which could take either of the values of either “gold” or “lead”. Thus, the property “current product” indicates whether the pressing machine is pressing gold bars or lead bars. A further example is the property “status”. This property is set according to whether the pressing machine is running or stopped.

This is summarised in the property table below:

Property Table

| Slot | Property ID | Current Value |
|---|---|---|
| Press Station | Current Product | Gold |
| Press Station | Status | Stopped |

The machinery “press station” is referred to as a “slot” whereas the actual physical piece of machinery occupying the slot is referred to as an “asset”. This allows pieces of machinery to be exchanged without the need to redefine all the events. The fact that the events are associated with slots rather than assets means that the machinery can be changed. The relationship between slots and assets is shown in the table below where the assets are referred to by serial numbers or the like:

Hierarchy Table

| Slot | Asset |
|---|---|
| Press Station | C0202P |
| Coiler Station | AB345D |

The table below shows the names of the events which have been defined and which relate to the press station machine. Each event represents a potential future occurrence in the machine. The press can stop, start, get changed over from lead to gold and vice versa during the production cycle and it sometimes suffers from a problem (“X”) which scraps the products being made. It is desirable to capture the running time and idle time of the press and the cost to the business of the problem.

Defined Events Table

Name
Stop
Start
Problem X
Change to Gold
Change to Lead

An event measure “cost of business” is defined in association with the event “problem X”. This measure is calculated by multiplying the number of products made per minute by the duration of the problem (in minutes) and then further multiplying this by the cost of each product.

Event Measures

| Event Name | Measure |
|---|---|
| Problem X | Cost to Business |

A further set of data is set up to determine how the properties are changed when an event is triggered. For example, when the event “change to gold” is triggered, the property “current product” is updated with the new value “gold”. The table below shows how each of the properties are updated as a result of each event being triggered.

Event Property Change

| Event Name | Property ID | New Value |
|---|---|---|
| Change to Gold | Current Product | Gold |
| Change to Lead | Current Product | Lead |
| Change to Gold | Status | Stopped |
| Change to Lead | Status | Stopped |
| Start | Status | Running |
| Stop | Status | Stopped |
| Problem X | Status | Stopped |

The following table is an example of a log of the events which have been captured from the start of production in the morning. Each event that is triggered is given the next consecutive event log number.

Event Log

| Time | Event Log No | Event Name |
|---|---|---|
| 06:00 | 1 | Change to Gold |
| 07:00 | 2 | Start |
| 07:20 | 3 | Problem X |
| 07:25 | 4 | Start |
| 08:00 | 5 | Change to Lead |
| 08:10 | 6 | Start |
| 08:40 | 7 | Problem X |
| 09:00 | 8 | Start |

The next table shows how the measure “cost of business” can be associated with any of the events. Since in this example we are interested in the cost to the business caused by problem X, the table below shows how the cost to business measure is calculated only with reference to the events logged as numbers 3 and 7.

Event Log Measures

| Event Log No | Measure | Measure value |
|---|---|---|
| 3 | Cost to Business | 1 × gold × 5 min |
| 7 | Cost to Business | 1 × lead × 20 min |

The following table is a “property change log” which gives figures for the duration that the various properties are at their various values. It is from this table that the duration figures are extracted in order to calculate the measure value in the “event log measures” table.

Property Change Log

| | | | | Begin Event |
|---|---|---|---|---|
| Time | Property ID | Value | Duration | Log No |
| 06:00 | Current Product | Previous prod | Mins since last | ? |
| 06:00 | Status | Previous state | Mins since last | ? |
| 07:00 | Status | Stopped | 60 | 1 |
| 07:20 | Status | Running | 20 | 2 |
| 07:25 | Status | Stopped | 5 | 3 |
| 08:00 | Current Product | Gold | 75 | 4 |
| 08:00 | Status | Running | 75 | 4 |
| 08:10 | Status | Stopped | 10 | 5 |
| 08:40 | Status | Running | 30 | 6 |
| 09:00 | Status | Stopped | 20 | 7 |

Using the above tables, users can set up properties against slots. Future property values are set up on the event themselves and as and when those events are triggered, values stored on the slot are updated. An audit trail of each property change is recorded with the duration of time for that value. Using this log of events and properties it can be determined what the value for each property was when an event was triggered and for how long the property was at a particular value.

In the above example, the “measure value” is calculated by referring to the value of the property “current product” in this way, the cost to business can be properly calculated even when products of drastically different value are being manufactured.

Further, user formulas and properties can be built and maintained, the results of which are then available to include in user KPI (Key Performance Indicators) reports, (i.e. Plant OEE Overall Equipment Effectiveness).

An example of this is shown in FIG. 9A and FIG. 9B. FIG. 9A shows a graph of when the machine was running and when it was not with time increasing along the x-axis.

It can be seen that the machine started at t₁₁, stops at t₂₁, restarted again at t₁₂ and stopped again at t₂₂. In order to track this, the user could define two events—“machine started” and “machine stopped”. These events could be triggered by the user every time the machine stops or starts or, advantageously, could be triggered automatically by the SCADA system. The machinery has what are called “properties” which are values that are based in the event log, the events such that interesting and usable data can be stored. The property “running time” corresponds to the calculation (t₂₁−t₁₁)+(t₂₂−t₁₂) for example.

Relationships which have not been conceived at the time of defining events can be set up later because there exists an audit trail of durations between each event being triggered and also between each property value changing. Thus, relationships can be set up later and useful data can be extracted from the raw audit trail data.

Event Suppression

Sometimes, to prevent misleading data, it is desirable not to record the occurrence of an event, even when the user operates the input means to indicate that the event had actually occurred. For example, it can be advantageous to set the system up such that the same event cannot be triggered in any, say, 5 minute interval. This is especially true of events which are triggered automatically by SCADA controllers, for example. Thus, if the SCADA controller is set to sample an oil temperature once every 30 seconds, and an event is triggered whenever this oil temperature is greater than a 70° C., when the oil overheats, an event will be triggered every 30 seconds until the oil has cooled down. It would be advantageous to suppress some of these repeat triggering so as to reduce the amount of data stored. This also applies when it is necessary to start and stop a machine many times during a start-up procedure (eg feeding the paper through a printing press).

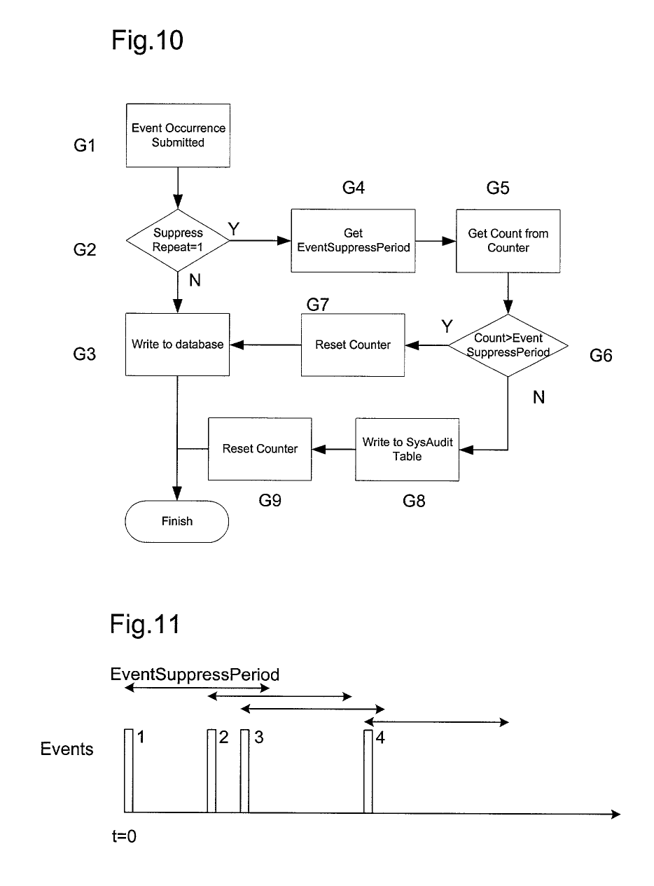

This is achieved using the procedure of FIG. 10. In step G1, the occurrence of an event is submitted to the controller, either automatically or by the user-operated input means 2. When the event was defined, it would be associated with a flag called “SuppressRepeat” and in step G2 it would be established whether this flag was set or not. If this flag is not set, (i.e. “SuppressRepeat” equals 0) the fact that the event occurrence has been submitted is written to the database 3 in step G3. If, “SuppressRepeat” has been set, a further value (“EventSuppressPeriod”) which was associated with the event upon its definition is obtained in step G4. This “EventSuppressPeriod” defines the amount of time for which further triggering of the event is suppressed after an initial triggering.

In step G5, a current value is obtained from a counter and in step G6 it is established whether or not the counter value is greater than the value “Event SuppressPeriod”. If the counter value is not greater, it means that an event was triggered within the time designated by “EventSuppressPeriod” so that the event should not be written to the database. Instead, the fact that the event was suppressed is written to an audit table not part of the main database (step G8). Optionally, the counter may then be reset so that any event occurrence which is submitted at a time within the period defined by “EventSuppressPeriod” in the future will be suppressed.

If in step G6 it is determined that the value of the counter is greater than the value “EventSuppressPeriod”, the counter is re-set (step G7) and the event occurrence is written to the database (step G3). If step G9 is omitted, only the first event occurrence which causes valid entry to be made to the database re-sets the counter. The effect of this is illustrated in FIG. 11. If an event occurrence is submitted at time t=0, further event occurrences submitted any time within the period “EventSuppressPeriod” are suppressed. Thus, the occurrence of the events numbered “2 and “3” are suppressed. If optional step G9 is used, the event suppress period is effectively re-set after each event, even if that event is suppressed. Thus, the submitting of event occurrence 2 extends the EventSuppressPeriod as does the submitting of event occurrence 3. In the case when step G9 is present, the submitting of event occurrence 3 would reset the EventSuppressPeriod such that the submitting of event 4 would be suppressed. If step G9 was not present, event occurrence 3 would be suppressed and any event occurrence submitted after the first EventSuppressPeriod would be registered. Thus, event occurrence 4 would be stored in the database if step G9 was not present but it would not be stored if G9 was present.

Technology Employed

The present invention is ideally implemented using a programmable computer system. The controller 1 comprising the event definer 11 and input means configurer 12 are preferably formed by a computer system which has a database 3 stored in memory and is connected or connectable to an input means 2, such as a keyboard or keypad

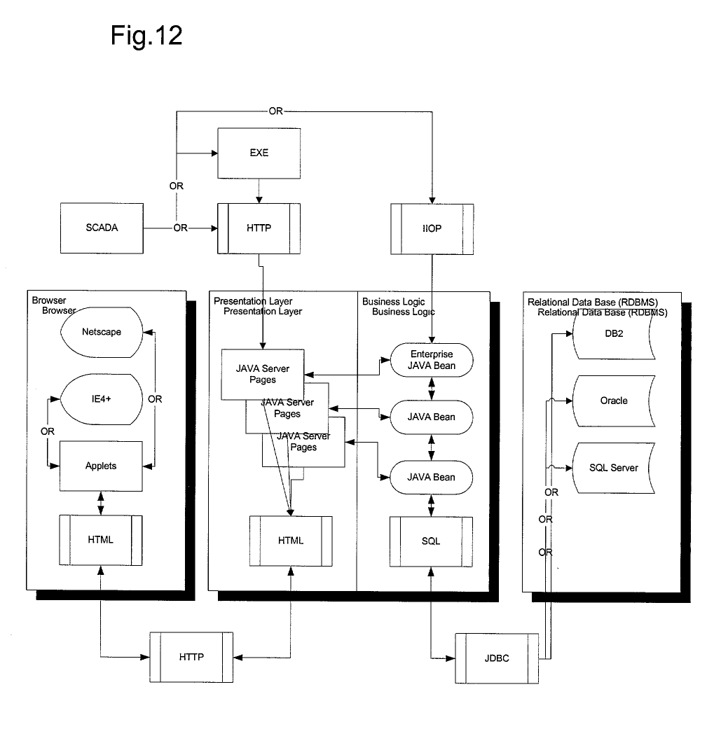

FIG. 12 shows possible alternative arrangements for the system deployed at a local installation. The system interface is typically a browser and the system is advantageously designed to operate under already existing internet protocols. FIG. 12 shows how the browser is connected to the presentation layer and ultimately to the relational database. The system of the present invention can obtain data from the SCADA system by polling the SCADA registers and obtaining XML files describing the values stored in such registers. The XML files are then written to the database via a Java bean.

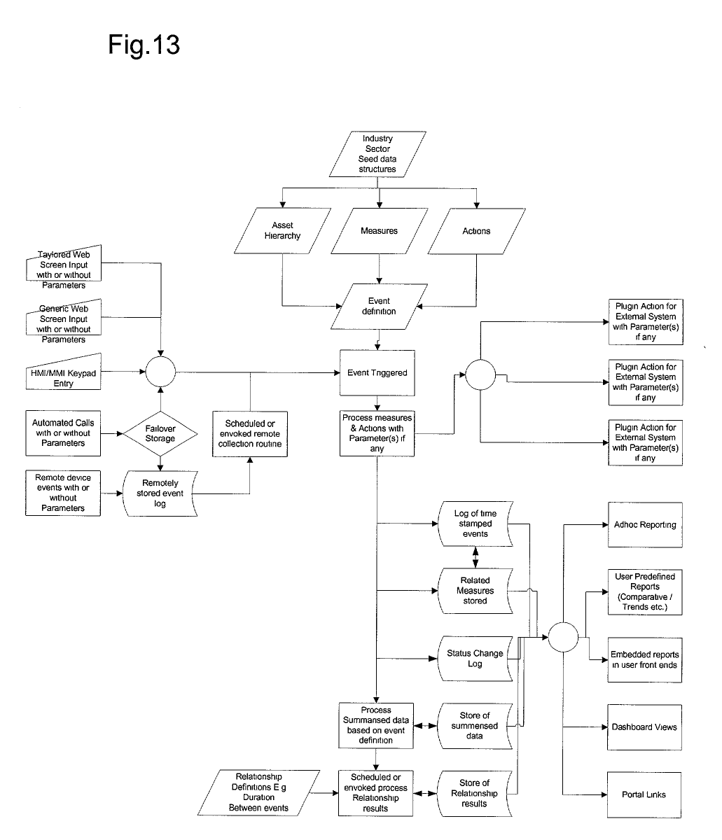

FIG. 13 gives an overview of how the system is structured. The input options are many and it is seen that the triggering of an event occurrence can lead to external actions being triggered as well as logging on a database; For example, when the occurrence of the event “boiler has overheated” is recorded, an action can be carried out automatically. Such actions are defined in a similar way to events using the system and may be warnings or other messages.

Actions

Actions may be thought of as escalations of an event, in other words, they are triggered as a result of an event occurrence is triggered and certain other conditions exist.

Event actions are defined against an event template. An event can have a number of actions associated with it that perform different tasks either within the events system or affecting another external system.

The method of how each action performs its task will be specified in code, however the Action plug-in is structured generically to enable MVL programmers to create new plug-ins for other systems as user requirements grow.

Possible actions include:

Raising a work order within an external CMMS system

Creating an asset meter or usage reading within an external CMMS system

Sending an email

Sending a pager message

Output to other Business System

Actions can be assigned to an event with specific criteria as to when the action should be triggered.

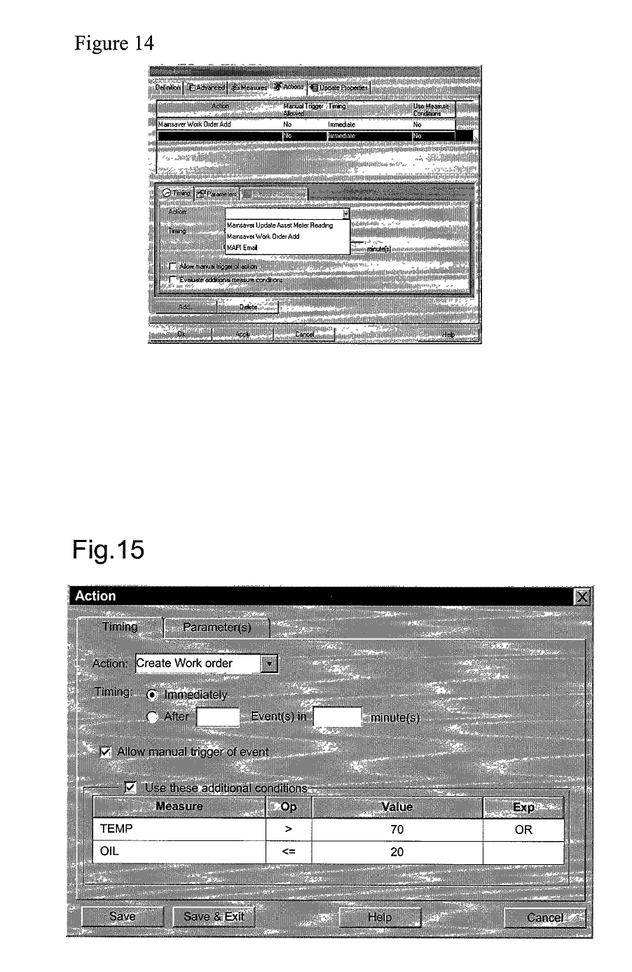

FIG. 14 shows a screen presented to a user which allows him to assign actions which are triggered when an event occurs. In this example, four actions have been assigned. The screen also allows the user to specify under what additional conditions the actions are carried out. For example, if the “Timing” tab is clicked, the screen of FIG. 15 is presented.

When the user is adding a new action then they may select the action from the drop-down list box which list actions defined in the ACTION table.

Next the user selects the timing mechanism required:

Immediately

Action is triggered immediately after the event has been logged

After [ ] events in [ ] minutes

Action is triggered after the specified number events have occurred within the specified time-period. E.g. Create work order after 5 of these events have occurred with the last hour (60 minutes).

Additional conditions may be applied if the ‘Use these additional conditions’ checkbox is checked.

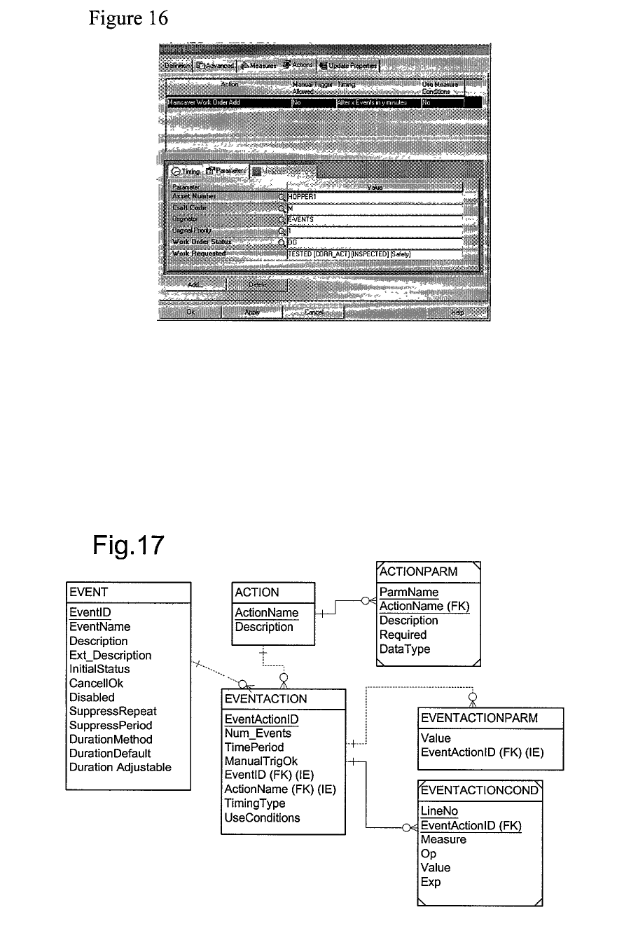

When the “Parameters” tab is clicked, the screen of FIG. 16 is presented.

Action Parameters screen details the values that will be passed as parameters to the external (or internal) system. The values for parameters can have drop-down selection lists or the fields may be freetext. In this case, the user must make sure the values entered are appropriate and valid for the external system otherwise the event action will fail.

Action parameters can be explict values or they can be a reference to a measure value captured by the event, or a mixture of the two:

For example,

| Parameter Value | |
|---|---|
| Example | Description |
| [FAILCODE] | will reference the value of the FAILCODE measure |
| | captured by this event. Note that measure codes will |
| | be referenced by placing them in square brackets |
| | ‘[]’. If this is not done then the text FAILCODE |
| | will treated as explicit, and not a reference to a |
| | measure. |
| Warning: Tempera- | will create the work requested field and substitute |
| ture is | the value of the temperature reading captured by the |
| [TEMP] degrees C. | TEMP measure to create the message: |
| | “Warning: Temperature is 54 degrees C.” |

Entity Relationship

FIG. 17 shows the relationship between entities of the present invention. The table below gives a brief description of each entity:

| | TABLE |
|---|---|
| | Description |
| ACTION | This is the list of available actions that can be |
| | chosen by the administrator when assigning |
| | actions to event templates. |
| ACTIONPARM | This is the list of parameter names that each |
| | action uses in specifying the interface to |
| | external system. |
| EVENTACTION | This is the list of actions that have been |
| | defined against an event template by selecting |
| | actions from the ACTION table. Timing in- |
| | formation is stored in this table for each |
| | event template. |
| EVENTACTIONPARM | This table stores the actual values for each |
| | parameter to be passed to the external (or |
| | internal) system |
| EVENTACTIONCOND | This table stores a list of event measure condi- |
| | tions that are evaluated by the system when |
| | considering to trigger the action. |
| | Event measure conditions are evaluated |
| | AFTER the timing parameters (in |
| | EVENTACTION) have been satisfied. |
| EVENT | The event template |

The tables below briefly describe what the individual fields of each entity relate to:

ACTION Table

| Column | Description |
|---|---|
| ActionName | The name of the action |
| Description | A textual description of the action |

ACTION PARM Table

| Column | Description |
|---|---|
| ActionName | The action the parameter belongs to |
| ParmName | The internal unique parameter name (usually the column |
| | name used in the external system) |
| Description | Textual description of the parameter presented to the user. |
| Required | Whether the parameter is required. |
| | 1 = Yes, 0 = No |
| DataType | A character presenting the datatype of the parameter. |
| | A = Alphanumeric |
| | N = Numeric |
| | D = Date or Datetime |
| | This is used within the user interface to validate the user |
| | entry of a parameter. |

NOTE: If an action parameter is specified by a reference to a measure rather than an explicit value then the validation should against the measure type not the string entered.
i.e. [Temp] is string, but it refers to a numeric measure called ‘Temp’ and therefore should be accepted.

EVENTACTION Table

| Column | Description |
|---|---|
| EventActionID | Unique internal counter for EVENTACTION table. |
| | This is used simply because you may wish the user to |
| | defined more than one action of the same type. |
| | E.g. two work order actions |
| Timing Type | A number representing the timing method of the action. |
| | 1 = Trigger action immediately on event entry |
| | 2 = Trigger action after X event occurrences in |
| | Y timeperiod. |
| Num_Events | The number of events specified in Timing Type 2 |
| | Cannot be null if timing type 2 selected |
| Timeperiod | The timeperiod specified in Timing Type 2 |
| | Cannot be null if timing type 2 selected |
| ManualTrigOk | Specifies whether the user is able to override the timing |
| | mechanism and trigger the action from the event instance |
| | edit screen. (see event edit screen) |
| UseConditions | Determines whether the measure conditions stored in the |
| | EVENTACTIONCOND table are evaluated. |
| | 1 = Evaluate conditions |
| | 0 = Do not evaluate conditions |

EVENTACTIONCOND Table

| Column | Description |
|---|---|
| Lineno | Unique internal counter for recording the order in which |
| | the event action conditions were entered and also as a |
| | unique line identifier. |
| Measure | The name of the measure to be evaluated |
| Op | The operator i.e. >=, >, <=, <, <> |
| | Additional set operators may be supported in later versions. |
| Value | The value |
| Exp | The boolean operator used to join this condition with the next. |
| | I.e. AND/OR |

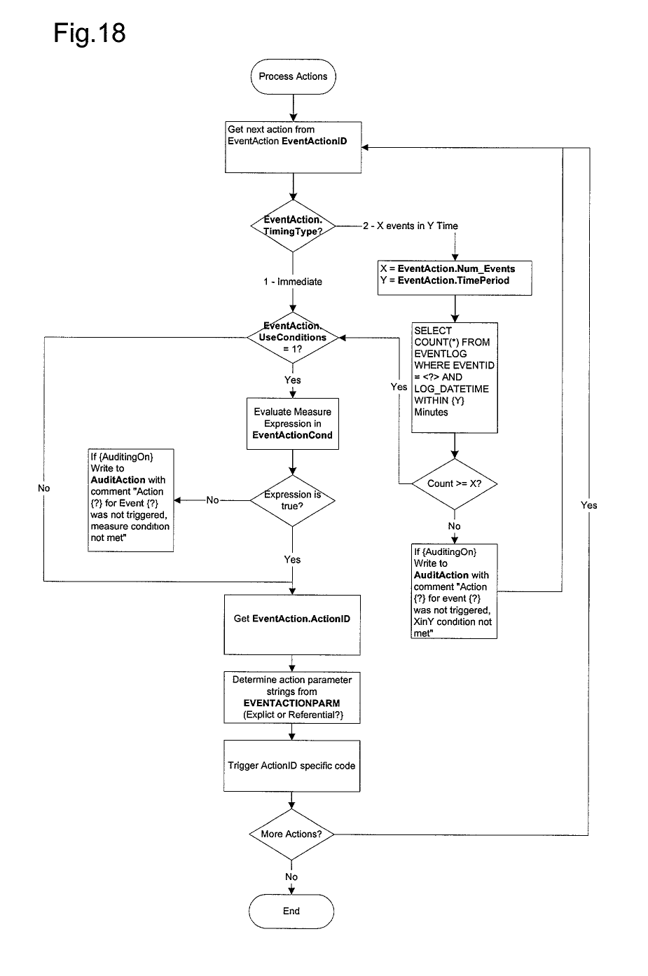

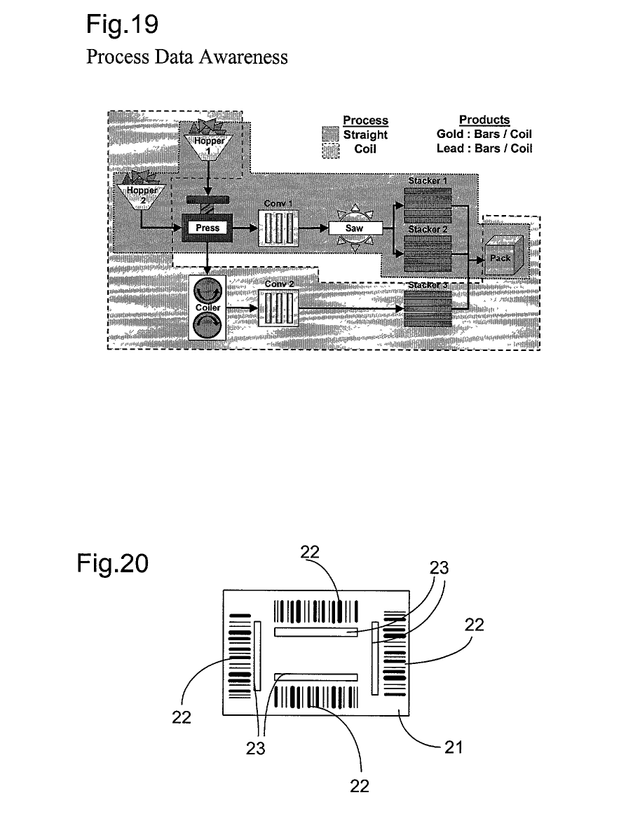

FIG. 18 is a flowchart describing how actions are processed according to the present invention. It can be seen from this that actions can be triggered as a result of a single event or the occurrence of a number of events in a set time period.

User Interface

The present invention is very easy to use and the user interface is preferably embodied in the form of a web page. When different users log onto the system, their “homepage” is displayed and this will typically show a graphical image of the machinery in which they are in charge of. By clicking on parts of the machinery, they can register the occurrence of an event associated with that part of the machinery or this could be used to trigger the display of a zoomed-in portion of the image of the machinery. Clicking on this zoomed-in image can then allow events to be triggered.

The use of internet technology allows the system to be set up on a central server with user terminals located remotely therefrom.

1. A method comprising:
providing a user with an alterable selection of conditions;
feeding back the user's assessment of the existence of one of these conditions; and
logging this assessment in a database.

2. A method according to claim 1, wherein each of said conditions comprises a potential future occurrence.

3. A method according to claim 1, wherein said selection of conditions is alterable in that conditions may be defined or removed.

4. A system for collecting and storing information about a process comprising:
a system controller comprising event defining means which allow an event to be defined by a user, said event being a potential future occurrence in said process;
input means connected or connectable to said system controller, said input means being operable to accept inputs relating to the occurrence of said pre-defined event;
said system controller further comprising means responsive to said event defining means for configuring said input means such that inputs to said input means cause the recording of the occurrence of said pre-defined event; and
a database stored in a memory for storing data relating to the fact that said pre-defined event occurred.

5. A system according to claim 4, wherein said system controller comprises a programmable computer loaded with software.

6. A system according to claim 4, wherein said event defining means allows a plurality of events to be defined and said input means is operable to accept a corresponding plurality of possible inputs.

7. A system according to claim 4, wherein said input means is operable remotely from said system controller.

8. A system according to claim 4, wherein a plurality of input means are provided, each being connected or connectable to said system controller and each being operable to accept inputs relating to the occurrence of one of the predefined events.

9. A system according to claim 4, further comprising display means corresponding to and provided with said input means and connected to said controller; wherein said controller is operable to cause said display means to display questions answerable using a corresponding input means.

10. A system according to claim 4, wherein said input means comprises a numeric keypad and the occurrence of an event is input by typing a number associated with said event.

11. A system according to claim 4, wherein said system controller further comprises database analysing means for analysing the contents of said database and for creating reports on the same.

12. A system according to claim 4, said system being operationally linked to apparatus involved in said process.

13. A system according to claim 12, wherein said controller is arranged to prevent said process from restarting once stopped and said controller is further arranged to allow said process to re-start once the occurrence of a pre-defined event has been recorded.

14. A method of collecting information, said method comprising:
using a programmed computer system to define an event, said event being a potential future occurrence in a process;
providing a monitor of the process with means to input the occurrence of said event;
using said input means to indicate to said programmed computer system that said event has occurred; and
storing the fact that said event has occurred in a database by storing data identifying said event.

15. A method according to claim 14, wherein said controller or said input means is also used to automatically measure when the occurrence of said event is inputted to obtain the time at which said event occurred and said storing step further comprises storing the time at which said event occurred.

16. A method according to claim 14, wherein said step of defining an event comprises inputting to said programmable computer system a description of said potential future occurrence.

17. A method according to claim 14, wherein a unique identifier is associated with each event, said unique identifier being a number, said input means comprising a numerical keypad and using said input means comprising inputting said number.

18. A method according to claim 14, further comprising:
analysing said database and calculating the number of times the event was stored in a selected time period.

19. A method according to claim 14, further comprising:
performing calculations using the data stored in said database so as to obtain values useful in making a business decision.

20. A method according to claim 19, wherein said potential future occurrence is a perceived fault in said process, said values comprise cost attributable to said fault and said business decision comprises a decision whether to continue monitoring said perceived fault.

21. A method according to claim 14, wherein said events are defined by a description of said potential future occurrence and a description of a potential reason for said future occurrence.

22. A method according to claim 21, wherein a plurality of different events have been defined.

23. A method according to claim 22, wherein a step of acknowledging the occurrence of an unknown event is carried out automatically by said programmable computer system and said monitor specifies which of said plurality of events has occurred by using said input means to indicate to said programmable computer system which of said plurality of events has occurred.

24. A method according to claim 23, wherein said step of acknowledging the occurrence of an unknown event is carried out when it is detected that there has been an irregularity in said process, said step comprising indicating to said monitor that the occurrence of an appropriate event should be input.

25. A method according to claim 24, further comprising the step of stopping said process and preventing it from being restarted until the monitor uses said input means to indicate the occurrence of one of said plurality of events.

26. A method according to claim 22, wherein said monitor uses said input means to indicate that an event has occurred and uses said input means in a separate step to indicate which event has occurred.

27. A method according to claim 26, wherein after indicating that an event has occurred, said programmable computer system displays one or more questions which must be answered by said monitor using said input means in said separate step, said answers identifying which of said plurality of events has occurred.

28. A method according to claim 14, further comprising: displaying information derived from said database on a real-time display.

29. A computer program which, when loaded on an appropriate programmable computer, carries out the following method:
allowing in an event defining step, a user to enter details of a potential future occurrence in a process;
receiving a signal from an input means provided to a monitor of said process;
analysing said signal from said input means and determining if said signal corresponds to said defined event; and
if said signal corresponds to said defined event, storing in a database the fact that said defined event has occurred-by storing data identifying said event.

30. A computer program according to claim 29, wherein said program, when loaded, allows a plurality of different events to be defined and stores a unique identifier associated with each defined event in a table with an entered description of the potential future occurrence to which the event relates.

31. A computer program according to claim 30, wherein said program, when loaded, is operable to interface with software controlling said process.

32. A computer program according to claim 31, wherein said program, when loaded, receives a signal from said input means after it receives a signal from said software controlling said process indicating that an irregularity has occurred in said process.

33. A computer program according to claim 32, wherein said program, when loaded, outputs a stop signal to said software controlling said process when it receives said signal indicating an irregularity.

34. A computer program according to claim 33, wherein said program, when loaded, only outputs a restart signal to said software controlling said process when it receives said signal from said input means corresponding to a defined event.

35. A computer program according to claims 29, wherein said program, when loaded, analyses said database and calculates the number of times that an event was stored in a selected time period.

36. A computer program according to claim 29, wherein said program, when loaded, allows a user to define calculations which the program applies to the data stored in said database so as to obtain values of interest to the user.

37. A computer program according to claim 29, wherein said program, when loaded, displays to said monitor one or more questions when said signal from said input means is received, said program being operable to analyse the answers to these questions and to identify which of the plurality of events has occurred.

38. A computer program according to claim 29, wherein said program, when loaded, displays information derived from said database on a real-time display.
